(19) United States
(12) Patent Application Publication
(10) Pub. No.: US 2019/0148781 A1
(43) Pub. Date: May 16, 2019

(54) BATTERY WITH SUPPRESSED MAGNETIC FIELD

(71) Applicant: BAE Systems Information and Electronic Systems Integration Inc., Nashua, NH (US)

(72) Inventors: Paul D. Zemany, Amherst, NH (US); David J. Herold, Hampstead, NH (US)

(21) Appl. No.: 15/812,392

(22) Filed: Nov. 14, 2017

(51) Int. Cl. H01M 10/42; H01M 2/10

(52) U.S. Cl. CPC H01M 10/4207; H01M 2220/20; H01M 2/1072

(57) ABSTRACT

A battery pack and a method of arranging battery cells therein. The battery pack includes a plurality of battery cells arranged and wired together to produce a suppressed or reduced magnetic field. The battery cells are arranged so that the positive and negative terminals of adjacent cells are alternated. Wiring connecting battery cells in pairs is twisted to minimize the area of the current loops in the battery pack. Wiring between battery cells that are adjacent each other is arranged to carry equal and opposite currents. The alternating terminal pattern and the manner in which the battery pack is wired results in the magnetic dipole moments of adjacent battery cells partially or fully cancelling each other out. The battery pack is suitable for use in Unmanned Aerial Vehicles (UAVs), Unmanned Underwater Vehicles (UUVs) or space-limited applications or devices, and makes it possible to use magnetic sensors in these devices.

### STATEMENT OF GOVERNMENT INTEREST

This present invention was made with United States Government support under Contract No. N00014-14-C-0112 awarded by the U.S. Department of Navy. The United States Government has certain rights in this invention.

### BACKGROUND

### TECHNICAL FIELD

This disclosure is generally directed to small battery powered Unmanned Aerial Vehicles (UAVs) or Unmanned Underwater Vehicles (UUVs) or any other application where a sensitive magnetic field sensor is used near a battery. More particularly, this disclosure relates to battery packs that may be utilized in UAVs and UUVs. Specifically, this disclosure is directed to a method of arranging the cells in a battery pack that minimizes the magnetic B field generated thereby, thus enabling the use of magnetic sensors (i.e., magnetometers) on a UAV or UUV or other battery powered devices.

### BACKGROUND INFORMATION

For navigation, magnetic sensors are commonly used to determine attitude. For example, air-borne objects such as rockets, missiles, UAVs and the like need to travel with precision guidance. Even with global positioning system (GPS) data, orientation information is typically lacking. In other examples, such as GPS-denied environments or undersea applications, magnetic sensors are an important element to the navigation and guidance. Since magnetic sensors are intended to respond to magnetic fields, they are also subject to magnetic field interference that may affect their operations.

UAVs or UUVs may be powered by a battery pack that tends to produce a significant magnetic field, particularly a significant B field. Even though some new battery cell chemistry does not employ magnetic materials, battery packs utilizing such materials tend to produce a significant B field due to the current. Battery packs used for a UAV or UUV main motor, for instance, may generate currents of 10A or more and the effective loop area could be greater than 10 cm². Due to the small form factor (i.e., size) of a UAV or UUV, this may result in a B field from the battery pack that exceeds 1 nT. Since modern atomic magnetometers have sensitivity better than 0.1 nT, presently known battery packs may be a significant background source of magnetism that will affect these types of sensors. Magnetic sensors are subject to significant interference from the current generated by presently known battery packs used in UAVs or UUVs and other space limited applications.

### SUMMARY

The inventors have recognized that changing the way in which the cells of a battery pack are arranged and connected will reduce the magnetic B field generated by the battery pack. They have further recognized that this reduction is possible for batteries that do not employ magnetic materials.

The present disclosure is directed to arranging battery cells in an optimal configuration and employing a manner of interconnecting wires that keeps the area of the current loops as small as possible. In particular, the battery cells are arranged in a specific pattern and the wiring for each pair of battery cells in the battery pack are twisted together. The two wires for the battery cells in each pair carry current that is flowing in opposite directions. The battery packs so produced tend to have a reduced B field and this makes it possible to use this type of battery pack in small devices such as UAVs or UUVs. In particular, because the battery pack has a reduced magnetic dipole moment, it is possible to use magnetic sensors in a UAV or UUV. Magnetic sensors may be used for a variety of purposes such as measuring the linear or rotary position of a device or the velocity thereof or sensing magnetic objects, geomagnetic survey operations, or attitude sensing. Consequently, being able to use such magnetic sensors on a UAV or UUV, satellites, projectiles, and other applications or devices that include or require confined spaces may be advantageous to the performance of these vehicles, applications or devices.

In one aspect, the present disclosure provides a first embodiment battery pack comprising a first battery cell and a second battery cell each having a positive terminal and a negative terminal; wherein the first battery cell and the second battery cell are arranged in a configuration where the positive and negative terminals are alternated; and wherein the first battery cell and the second battery cell each generate a magnetic dipole moment; and wherein the magnetic dipole moment of the first battery cell at least partially cancels out the magnetic dipole moment of the second battery cell.

The first and second battery cells are arranged in a side-by-side configuration in a first stack and are oriented in the first stack such that the positive terminal of the first battery cell is adjacent the negative terminal of the second battery cell; and the negative terminal of the first battery cell is adjacent the positive terminal of the second battery cell. The battery pack in one example comprises a plurality of battery cells including the first battery cell and the second battery cell; wherein each of the plurality of battery cells has a positive terminal and a negative terminal; and wherein the first stack includes the plurality of battery cells arranged in side-by-side configuration; and wherein the first stack is configured such that at a first end of the first stack the positive and negative terminals alternate and at a second end of the first stack, the negative and positive terminals alternate. The plurality of battery cells are arranged in the first stack in series or in parallel. The term “side-by-side” should be understood to represent a battery where each cell has a first end, a second end and a side wall extending between the first and second ends; and where the side wall of a first battery cell is positioned in close proximity or contact with the side wall of a second battery cell. The term “side-by-side” should be understood to be describe a battery where battery cells that are placed right next to each other (i.e., adjacent each other) may be oriented vertically or horizontally. In one example, if the battery cells are in the vertical orientation, alternating first and second ends of the battery cells are oriented parallel to a horizontally oriented surface and the side walls of those batteries cells are oriented at right angles to the horizontally oriented surface. In another example, if the battery cells are stacked one above the other and are in the horizontal orientation, the side walls of the battery cells are oriented substantially parallel to the horizontally oriented surface and the first and second ends of the battery cells are oriented substantially at right angles to the horizontally oriented surface.

In other aspects the disclosure provides a battery pack wherein the first battery cell and the second battery cell each generate a magnetic dipole moment; and wherein the magnetic dipole moments of the first and second battery cells when arranged in the first stack at least partially cancel each other out. The first stack in another example comprises additional battery cells, wherein the additional battery cells are arranged in pairs such that magnetic dipole moments generated by the additional battery cells in each pair at least partially cancel each other out.

The battery pack in another embodiment further comprises a second stack of battery cells operatively engaged with the first stack; wherein the second stack of battery cells is positioned in end-to-end relationship with the first stack; and wherein the second stack of battery cells comprises a plurality of battery cells stacked together in a side-by-side configuration; wherein each of the plurality of battery cells in the second stack includes a positive terminal and a negative terminal; and wherein the battery cells in the second stack have alternating positive and negative terminals at a first end of the second stack and alternating negative and positive terminals at a second end of the second stack; and wherein the second stack is positioned adjacent the first stack such that the alternating positive and negative terminals at the first end of the second stack are located adjacent oppositely oriented negative and positive terminals at the second end of the first stack. Each of the first stack and the second stack has an even number of battery cells therein and the number of battery cells in the first stack is the same as the number of battery cells in the second stack.

In another aspect, the disclosure provides a battery pack wherein the plurality of battery cells is arranged in the first stack to minimize an area of one or more current loops in the first stack. Wiring connects pairs of battery cells together in the first stack and the wiring for each pair of battery cells is twisted to minimize the area of the one or more current loops in the first stack.

The battery pack may be installed in an Unmanned Aerial Vehicle (UAV) or an Unmanned Underwater Vehicle (UUV) or any other application or device that includes a constrained volume comprising a housing; along with a magnetic sensor provided in or on the housing of the UAV or the UUV, wherein the magnetic sensor or the application tolerates x-amount of magnetic interference; and a battery pack located within the housing to provide power to the UAV or the UUV; and wherein the battery pack includes a plurality of battery cells arranged to produce a suppressed magnetic field and the suppressed magnetic field generates less than x-amount of magnetic intereference.

In one example to support the navigation function in a small UAV, a 3 axis flux gate magnetometer is placed 0.2 meters from the battery. A typical, unmodified, high capacity battery (i.e, a PRIOR ART battery) used for UAV flight power provides 20 amperes and can produce about 3000 nT at 0.2 meter. This could produce a bias of 8 degrees in heading. The inventors have recognized that there is a need to reduce the B field of a battery used in this application in order to reduce the impact on the heading of the UAV. The inventors have further recognized that to provide a heading bias of <1 degree, the field from the battery should be <300 nT. The x-amount of magnetic interference provided by a battery for a small UAV fabricated in accordance with the present disclosure is therefore <300 nT.

In a second application, such as geological study, a sensitive scalar magnetometer is installed in a UAV to produce a map of changes in the magnetic field magnitude. Any changes in battery current will tend to produce false changes in the map. Furthermore, even if the battery current is constant, the fixed magnetic B field due to battery current will still tend to produce false changes in the map if the UAV rotates. PRIOR ART batteries tended to interfere with the mapping process by producing false changes in the measured B field magnitude. If a sensitive Atomic scalar magnetometer is used, the inventors have determined that limiting the effect of the battery (i.e., the x-amount of magnetic interference) to be less than 1-2 nT at the sensor location is desirable. For limited space applications as in the small UAV, the sensor is constrained to be <0.5 meter from the battery. A typical, unmodified, high capacity battery (i.e., PRIOR ART battery) used for UAV flight power provides 10-20 amperes and can produce about 200 nT at 0.5 meter. The present disclosure relates to a battery suitable for this application and in which the B field of the battery is reduced to less than 1-2 nT at the sensor location.

The battery pack of the present disclosure is comprised of the plurality of battery cells arranged in a side-by-side configuration to form a stack; wherein each battery cell in the stack has a positive terminal and a negative terminal; and wherein a first side of the stack has alternating positive and negative terminals and a second side of the stack has alternating negative and positive terminals. Each of the plurality of battery cells in the stack generates a magnetic dipole moment; and wherein the magnetic dipole moments of battery cells that are adjacent each other in the stack at least partially cancel each other out so that the field at the magnetic sensor is less than x (where in some applications, as described above, x<300 nT and in other applications x<1-2 nT).

In yet other aspects, the disclosure may provide a method of reducing a magnetic dipole moment of a battery pack comprising providing a plurality of battery cells including a first battery cell and a second battery cell, wherein each of the plurality of battery cells has a positive terminal and a negative terminal; arranging the first and second battery cells to form a stack by: positioning the first battery cell in a first orientation where the positive terminal of the first battery cell is on a first side of the stack and the negative terminal of the first battery cell is on a second side of the stack; and positioning the second battery cell in a second orientation where the positive terminal of the second battery cell is on the first side of the stack and the negative terminal of the second battery cell is on the second side of the stack. The method may further comprise at least partially canceling a magnetic dipole moment of the first battery cell with a magnetic dipole moment of the second battery cell. The plurality of battery cells includes additional battery cells other than the first battery cell and the second battery cell; and wherein the method further comprises alternating the first and second battery cells and the additional battery cells in the stack between the first orientation and the second orientation.

In other aspects, the method may further comprise arranging the plurality of battery cells in wiring pairs; balancing a current produced by a first battery cell in a first wiring pair with a current produced by a second battery cell in the first wiring pair; and wiring the first battery cell to the second battery cell. The method may further comprise twisting wiring between the first battery cell and the second battery cell in the first wiring pair; and minimizing an area of a current loop from the first wiring pair.

In still further aspects the disclosure may provide a method installing the battery pack in a UAV or UUV that has one or more magnetic sensors or one or more applications, wherein each of the one or more magnetic sensors or the one or more applications tolerates x-amount of magnetic interference; and generating less than x-amount of magnetic interference from the battery pack

### BRIEF DESCRIPTION OF THE SEVERAL VIEWS OF THE DRAWINGS

Sample embodiments of the present disclosure are set forth in the following description, is shown in the drawings and is particularly and distinctly pointed out and set forth in the appended claims.

FIG. 1 is a diagrammatic view of two individual battery cells shown spaced a distance apart from each other and showing the individual magnetic dipole moments produced thereby;

FIG. 2 is a diagrammatic view of a PRIOR ART battery pack in which two cells are stacked one on top of the other in an in-line configuration and showing the net magnetic dipole moment produced thereby;

FIG. 3 is a diagrammatic view of a battery pack in accordance with an aspect of the present disclosure and in which two cells are stacked one on top of the other in an alternating configuration and showing the reduced net magnetic dipole moment produced thereby;

FIG. 3A is a diagrammatic view of a two cell battery pack showing the wiring twisted together;

FIG. 4 is a diagrammatic view of a first exemplary arrangement of a battery pack including ten battery cells arranged in series;

FIG. 5 is a diagrammatic view of a second exemplary arrangement of a battery pack including ten battery cells arranged in series;

FIG. 6 is a diagrammatic view of a third exemplary arrangement of a battery pack including eight battery cells arranged in parallel;

FIG. 7 is a perspective view of a connectorized battery pack showing the alternating configuration of two stacks of battery cells and the wiring that connects the same;

FIG. 8 is a diagrammatic view of a UAV with the battery pack in accordance with the present disclosure and utilizing at least one magnetic sensor;

FIG. 9 is a graph showing the results of an exemplary testing of a PRIOR ART battery pack and a battery pack in accordance with the present disclosure; and

FIG. 10 is a flow chart showing the method of the present disclosure.

Similar numbers refer to similar parts throughout the drawings.

### DETAILED DESCRIPTION

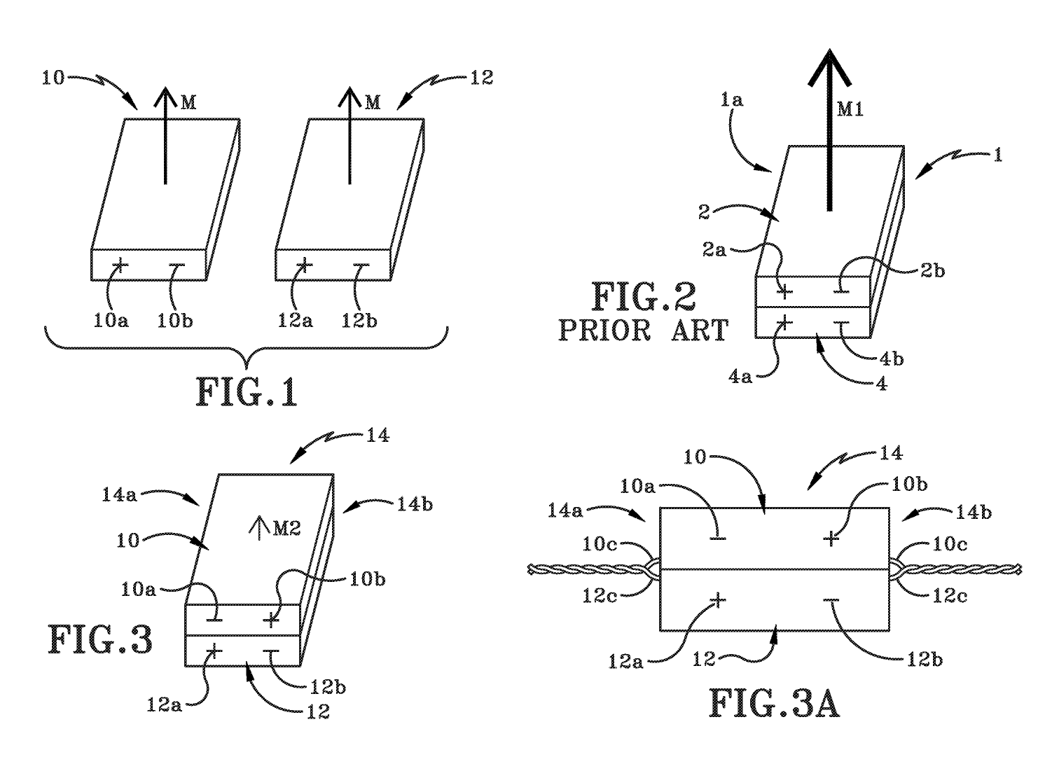

Referring to FIG. 1, there is shown a first battery cell 10 and a second battery cell 12. First battery cell 10 has a positive terminal 10a and a negative terminal 10b and generates a magnetic dipole moment “M”. Second battery cell 12 has a positive terminal 12a and a negative terminal 12b and also generates a magnetic dipole moment “M”. The dipole moments “M” for the two battery cells 10, 12 are the same because the first and second battery cells 10, 12 are identical and generate the same current.

FIG. 2 shows an exemplary conventional PRIOR ART battery pack 1 produced by stacking a first battery cell 2 on top of a second battery cell 4. First battery cell 2 has a positive terminal 2a and a negative terminal 2b. Second battery cell 4 has a positive terminal 4a and a negative terminal 4b. This PRIOR ART battery pack 1 is arranged in what may be termed an “in-line configuration”, i.e., the positive terminals 2a, 4a of the first and second battery cells 2, 4 are stacked in-line or one above the other. Additionally, the negative terminals 2b, 4b of first and second battery cells 2, 4 are stacked in line or one above the other. In other words, all the positive terminals 2a, 4a are arranged proximate a first side 1a of battery pack 1 and all the negative terminals 2b, 4b are proximate a second side 1b of battery pack 1.

PRIOR ART battery pack 1 produces a magnetic dipole moment “M1” that is greater than the magnetic dipole moments of the individual battery cells 2, 4. (It should be understood that more than two battery cells 2, 4 may be utilized in battery pack 1 but only two battery cells have been illustrated and discussed herein for the same of simplicity and clarity.) Magnetic sensors can only tolerate x-amount of magnetic interference. The magnetic dipole moment “M1” is of a size that may interfere with magnetic sensors or magnetometers provided on a device. In other words, the magnetic dipole moment “M1” is greater than the x-amount of magnetic interference that a magnetic sensor can tolerate. The application or device in which the PRIOR ART battery pack is used, rather than the sensor itself, might be problematic. In other words the sensor may be able to tolerate the magnetic field from a battery, but the field from the battery may limit the application (e.g. interfere with attitude estimate or detection). It may also be possible that the magnetic field of a conventional PRIOR ART battery could saturate the magnetic sensor and make it useless.

The conventional systems employing battery cells in some examples did not have size concerns and therefore the batteries could be kept a sufficient distance apart from the magnetic sensors or insulating materials could be placed between the battery and magnetic sensor so that the magnetic field from the batteries did not interfere with the magnetic sensor. In many cases, the parties did not measure or factor magnetic interference with the sensor from the battery into their design criteria. It was not until the present inventors deployed the battery cells into a tight configuration and analyzed the performance characteristics of the magnetic fields that the present techniques became apparent.

FIG. 3 illustrates an exemplary battery pack 14 in accordance with the present disclosure. Battery pack 14 may be fabricated by stacking first battery cell 10 on top of second battery cell 12. First and second battery cells 10, 12 may be substantially identical in structure and size and produce substantially the same amount of current. Battery pack 14 is arranged in what may be termed an “opposing or alternating configuration”. The first battery cell 10 is arranged in battery pack 14 so that the negative terminal 10a thereof is positioned adjacent a first side 14a of battery pack 14 and the positive terminal 10b thereof is positioned adjacent a second side 14b thereof. The second battery cell 12 is rotated through 180 degrees so that the negative terminal 12b thereof is located adjacent the first side 14a of battery pack 14 and the positive terminal 12a thereof is on the second secede 14b of battery pack 14.

As a result of this change in orientation of second battery cell 12 relative to first battery cell 10, positive terminal 10b of first battery cell 10 is positioned adjacent or proximate negative terminal 12b of second battery cell 12. Additionally, negative terminal 10a of first battery cell 10 is positioned adjacent or proximate positive terminal 12a of second battery cell 12. The effect of this reversal in orientation of the second battery cell 12 relative to first battery cell 10 is that the resultant magnetic dipole moment “M2” of battery pack 14 is substantially reduced. Magnetic dipole moment “M2” is reduced because the magnetic dipole moment “M” (FIG. 1) of first battery cell 10 partially or fully cancels out the magnetic dipole moment “M” of second battery cell 10. Magnetic dipole moment “M2” produced by battery pack 14 is negligible and therefore may not substantially affect magnetic sensors (magnetometers) if utilized in a UAV or UUV. In other words, the magnetic dipole moment “M2” is less than the x-amount of magnetic interference that a magnetic sensor can tolerate.

FIG. 3A shows the wiring 10c, 12c of the two battery cells 10, 12 twisted together in such a way that there are at least three twists per inch of wire. The current in wire 10c flows in an opposite direction to the current in wire 12c. If more than two battery cells are incorporated into the battery pack then each pair of adjacent cells will include wiring that is twisted together in the same manner as is shown with respect to battery cells 10, 12 in FIG. 3A. In other words, the battery pack includes wiring that operatively engages the plurality of battery cells 10, 12 together; and adjacent battery cells in each pair of battery cells in the battery pack are oriented with their positive and negative terminals opposite each other and the wiring for each pair of battery cells is twisted and carries equal and opposite currents. Additionally, wires that interconnect cell stacks in the battery pack are also twisted together in a similar fashion to the wires for pairs of adjacent battery cells. Still further, the wires that supply current to the motor or to any other powered device in the UAV may also be twisted in this manner.

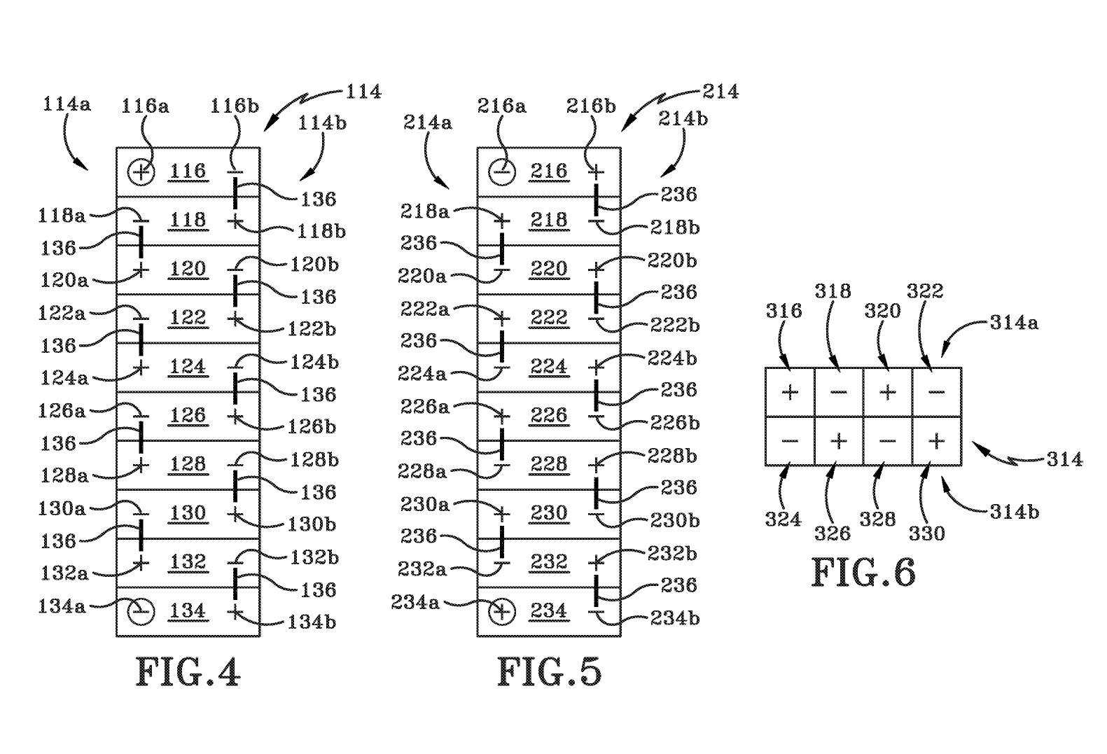

FIG. 4 illustrates the stacking of a ten-cell battery pack 114 in accordance with the present disclosure. Battery pack 114 includes battery cells 116, 118, 120, 122, 124, 126, 128, 130, 132, and 134. Each of the batteries includes a positive terminal and a negative terminal. Battery cell 116 has positive terminal 116a and negative terminal 116b. Battery cell 118 has positive terminal 118a and negative terminal 118b. Battery cell 120 has positive terminal 120a and negative terminal 120b. Battery cell 122 has positive terminal 122a and negative terminal 122b. Battery cell 124 has positive terminal 124a and negative terminal 124b. Battery cell 126 has positive terminal 126a and negative terminal 126b. Battery cell 128 has positive terminal 128a and negative terminal 128b. Battery cell 130 has positive terminal 130a and negative terminal 130b. Battery cell 132 has positive terminal 132a and negative terminal 132b. Battery cell 134 has positive terminal 134a and negative terminal 134b. Connectors 136 secure battery cells that are adjacent each other together.

As is evident from FIG. 4, battery cells 116-134 are arranged so that the positive and negative terminals alternate along a first side 114a of battery pack 114 and along a second side 114b thereof. The circled terminals (116a and 134a) are the outputs of the battery pack 114.

FIG. 5 illustrates an alternative arrangement for stacking of a ten-cell battery pack 214 in accordance with the present disclosure. Battery pack 214 includes battery cells 216, 218, 220, 222, 224, 226, 128, 230, 232, and 234. Each of the batteries includes a positive terminal and a negative terminal. Battery cell 216 has positive terminal 216a and negative terminal 216b. Battery cell 218 has positive terminal 218a and negative terminal 218b. Battery cell 220 has positive terminal 220a and negative terminal 220b. Battery cell 222 has positive terminal 222a and negative terminal 222b. Battery cell 224 has positive terminal 224a and negative terminal 224b. Battery cell 226 has positive terminal 226a and negative terminal 226b. Battery cell 228 has positive terminal 228a and negative terminal 228b. Battery cell 230 has positive terminal 230a and negative terminal 230b. Battery cell 232 has positive terminal 232a and negative terminal 232b. Battery cell 234 has positive terminal 234a and negative terminal 234b. Connectors 236 secure battery cells that are adjacent each other together.

As is evident from FIG. 5, battery cells 216-234 are arranged so that the negative and positive terminals alternate along a first side 214a of battery pack 214 and along a second side 214b thereof. The circled terminals (216a and 234a) are the outputs of the battery pack 214. A comparison of FIGS. 4 and 5 shows that the outputs for the two battery packs 114, 214 are reversed. Although not shown in these figures, the wiring interconnecting the battery cells may be designed using twisted pairs with equal and opposite currents in all pairs as this reduces a size of overall area (i.e., the length×height×width) occupied by the current loops even though more wire might be utilized to connect the battery cells to each other.

FIG. 6 shows a battery pack 314 that includes eight battery cells that are stacked in two rows of four cells. A first row includes battery cells 316, 318, 320 and 322. A second row includes battery cells 324, 326, 328 and 330. The alternating positive and negative terminals along a first side 314a and a second side 314b of battery pack 314 are shown. Again, the wiring (not shown) interconnecting the battery cells should be arranged in twisted pairs with equal and opposite currents.

In each of the illustrated battery packs 114, 214 and 314 the magnetic dipole moment of the pack is significantly reduced because of the rotation of every second battery cell in the pack and therefore alternating positive and negative terminals. The result of this configuration is that adjacent cell moments are canceled, thus reducing the overall magnetic dipole moment of the pack. When producing a battery pack that is desired to have a low magnetic signature, the moment of each cell to be used in the battery pack needs to be established and then the optimal configuration of those cells in the pack is established by arranging the cells to cancel out adjacent cell moments as this will minimize the net battery pack moment.

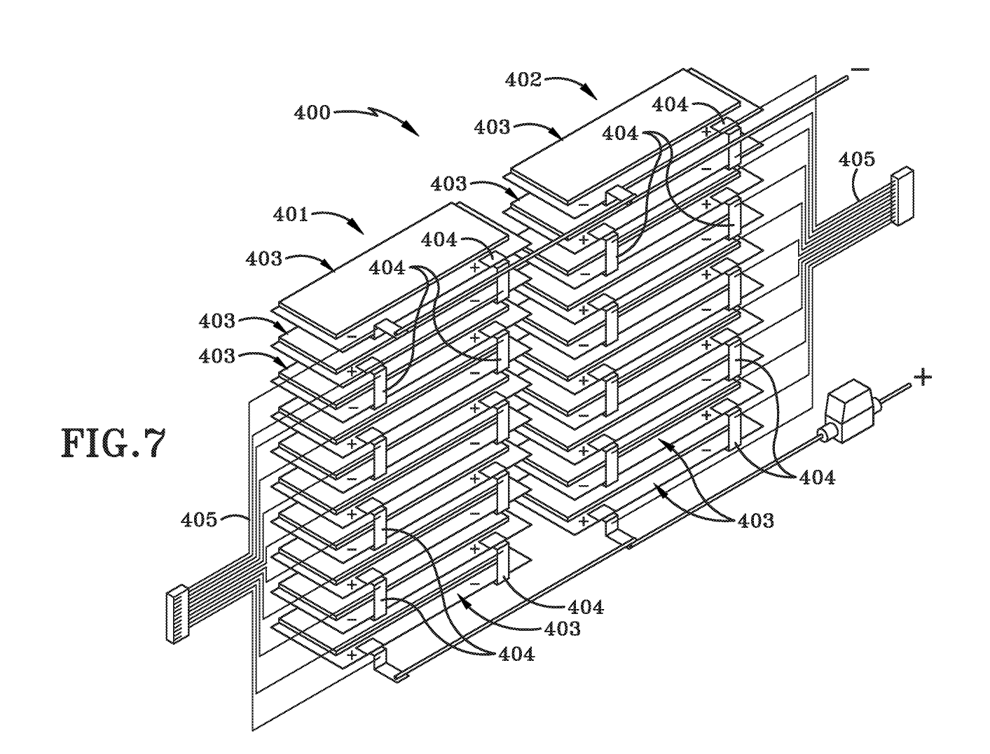

FIG. 7 shows a battery 400 comprised of a plurality of battery cells 403 arranged in a first stack 401 and a plurality of battery cells arranged in a second stack 402. Battery cells in first stack 401 and in second stack 402 are arranged in a similar fashion to the battery pack 214 illustrated in FIG. 5. Adjacent cells 403 are rotated relative to each other such that the positive and negative terminals thereof alternate in the stack. Connectors 404 secure oppositely oriented battery cells 403 that are adjacent each other together. Wiring 405 interconnects battery cells 403 together. The current loops formed by wiring 405 are kept as small as possible by arranging battery cells 403 in the illustrated alternating terminal pattern and by twisting wiring pairs. The wiring is designed using twisting pairs with equal and opposite currents in all pairs. The interconnecting wires between battery cells 403 and to external systems should be twisted (i.e., wrapped around each other) and current balanced to aid in minimizing an area of current loops in battery 400. Battery 400 will thereby include equal and opposing current loops that are arranged in pairs.

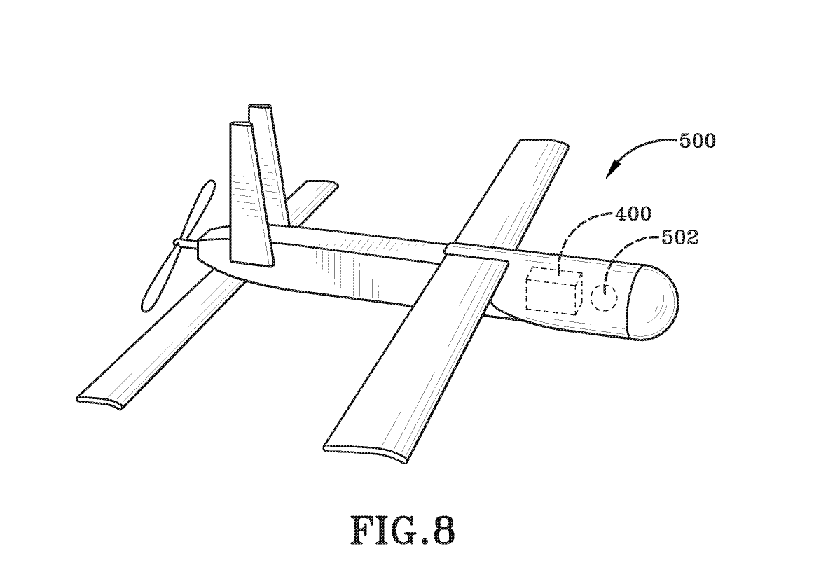

The following is an example of how the battery pack in accordance with the present disclosure may be used. FIG. 8 is a diagrammatic view of an exemplary UAV 500 that includes a battery pack in accordance with the present disclosure, such as battery pack 400, and utilizing one or more magnetic sensors 502. Only one sensor is illustrated in this figure but it will be understood that additional magnetic sensors may be provided in UAV 500. Battery pack 400 and sensor 502 may be located within an interior of the UAV's housing. Alternatively, sensor 502 may be provided on an exterior of the housing. Magnetic sensors may be of any of a variety of different sensitivities. A magnetic sensor selected for a particular application will be selected based on the sensitivity required for that application. Since there is this variation in sensitivity, the amount of magnetic interference any particular sensor can tolerate will be described herein as being “x-amount” of magnetic interference. Sensor 502 may be able to tolerate x-amount of magnetic interference and still function properly. If there is more than x-amount of magnetic interference from a battery pack then the sensor 502 may not be able to function properly. For any particular application, the reduced B-field produced by battery pack 400 is designed to generate less than x-amount of magnetic interference and, consequently, magnetic sensor 502 may function properly.

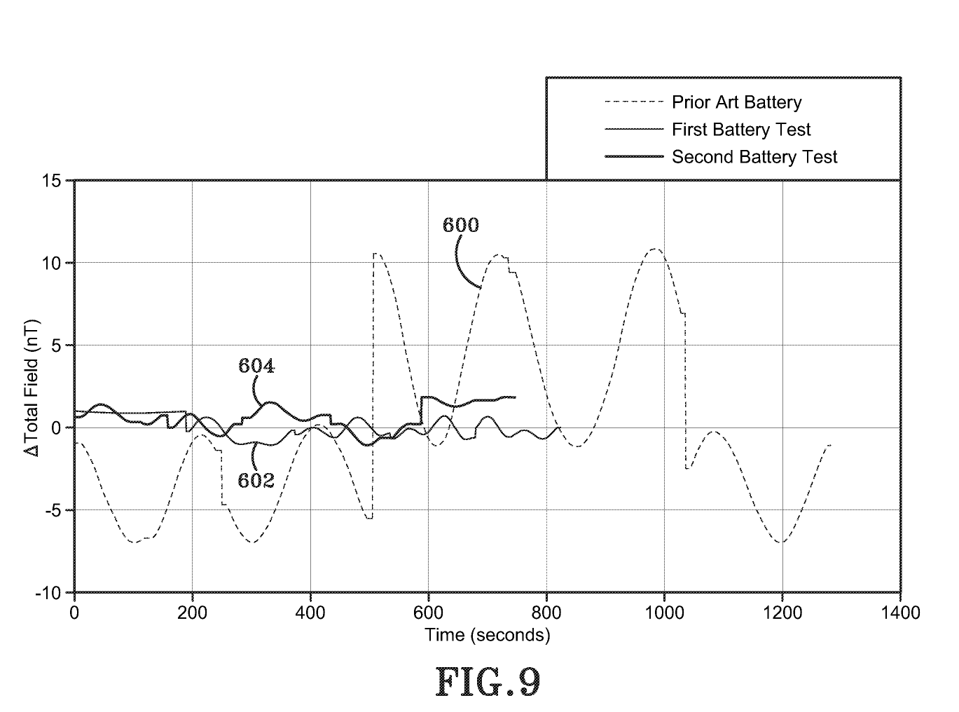

FIG. 9 is a graph showing testing of a PRIOR ART battery pack relative to two separate tests of a battery pack in accordance with the present disclosure. The PRIOR ART battery pack and battery pack in accordance with the present disclosure were both dimethyl oxalate (DMO) battery packs. The battery packs in accordance with the present disclosure were arranged in the configuration disclosed above. DMO battery cells are non-magnetic.

It should be noted that magnetic battery cells, such as nickel cadmium battery cells, are not contemplated to be useful in battery packs in accordance with the present disclosure. Nickel is a magnetic material. Consequently, a nickel cadmium battery has a magnetic field, even if current is not being produced. When current is being produced by a magnetic battery cell, the size of the magnetic field increases. Consequently, arranging battery cells to cancel out the magnetic dipole moment resulting when current is produced does nothing to reduce the magnetic field generated by the magnetic materials in the battery cell. Magnetic battery cells therefore still have a magnetic field that may interfere with a magnetic sensor.

On the other hand, utilizing non-magnetic materials in a battery cell will result in a magnetic field only being generated when current is produced by the battery cell. Arranging such non-magnetic battery cells so that the positive and negative terminals alternate therefore tends to reduce the magnetic field due to current production. With the magnetic field mitigated, a battery pack in accordance with the present disclosure therefore permits the battery pack to be utilized more readily around sensitive magnetic sensors.

Various factors determine if a particular battery pack will adversely affect a magnetic sensor. Such factors may include the sensitivity of the magnetic sensor, the distance between the sensor and the battery pack and the size of the magnetic dipole moment of the battery pack. For example, magnetic sensors used in geological survey applications may be able to tolerate less than 1 nT. Magnetic sensors used for magnetic compasses, on the other hand, may be able to tolerate about 100 nT. It should be noted that the B field about six inches away from a one foot long battery pack can be about 5000 nT for a 10 amp current. Obviously, locating a magnetic sensor in a geologic survey application or a magnetic compass within six inches of such a battery pack would have adverse effects on that magnetic sensor.

A plurality of tests were conducted to determine the effect of arranging a battery pack 400 as described above and shown in FIGS. 2-8 relative to a PRIOR ART battery pack. The battery packs to be tested were affixed to a non-magnetic platform device and the platform device was slowly rotated about an axis and the output of a sensor on the platform was recorded. The change in magnetic field was measured as the platform device was rotated over a period of time. Sampling was conducted at about 20 H.

A PRIOR ART battery pack was placed on the platform device. The magnetic dipole moment of the battery pack was measured and recorded over the period of time of the test. The change in Total Field was plotted against the testing time in seconds. (Total Field is a measurement of the Earth's magnetic field plus the magnetic dipole moment of the battery pack. The change in Total Field (i.e., ΔTotal Field) is the magnetic field of the battery added to or subtracted from the Earth's magnetic field.) As is evident from the graph of FIG. 9, the PRIOR ART battery shows a B field variation of from about −7 nT up to about +12 nT.

In a first test of the battery pack 400, the battery pack 400 was placed on the platform device and the platform device was rotated for a first period of time. In a second test of the same battery pack 400, the platform device was rotated for a second period of time. As is evident from FIG. 9, in both of the first test and the second test, the B field variation is from about −1 nT up to about +1 nT. In other words, the magnetic dipole moment of battery pack 400 approximates 0 nT. Over a period of similar tests, it has been found that arranging battery cells with alternating positive and negative terminals and twisting the wiring thereof in accordance with the present disclosure results in about a 15:1 reduction in the B field produced by internal battery current of the battery pack 400.

With the reduced or suppressed magnetic field in battery pack 400, the sensor 502 (FIG. 8) and battery pack 400 may be placed in closer proximity to each other than would be the case if a PRIOR ART battery pack was used in the same application. As a result, magnetic sensors 502 and battery pack 400 may be used in smaller, more confined spaces with adversely impacting the performance of sensor 502. Furthermore, the use of battery pack 400 may also permit for the use of more sensitive magnetic sensors than would be the case if a PRIOR ART battery pack was used.

The disclosed method of configuring battery pack 400 may therefore reduce the B field by at least 1/15. With more precise and compact wiring and alternating negative and positive terminals, the reduction in B-field may approximate 1/80. To design a system using the battery pack 400 and sensor 502, the following specific details preferably should be addressed; namely, the required current for the application or device; the space limit provided by the application or device (i.e., proximity of the magnetic sensor to the battery pack), and the maximum field limit any particular magnetic sensor can tolerate. In stacking the battery cells in battery pack 400, a more precise packing may be needed for a greater B field reduction factor. It has also been determined that it may be better to produce battery pack with many small battery cells rather than a few large battery cells. It has further been determined that battery cell to battery cell uniformity allows for a more precise cancellation of the B field. While cell to cell uniformity is desirable, including different or non-uniform size/current battery cells but utilizing the principles of alternating positive and negative terminals and twisting wiring will still result in at least partial reduction in the B field and thereby offer at least some of the benefit s of the present disclosure.

It should be understood that while the present disclosure has been directed to a battery pack that has a reduced dipole moment and can therefore be used in a UAV or UUV, it will be understood that such a battery pack could be used in any application that requires a battery with a low magnetic signature. For example, operating a magnetic sensor in a projectile would be desirable and the sensor would need to be close to any battery pack used in the projectile. Utilizing a PRIOR ART battery in such an application would result in the current produced by the PRIOR ART battery pack interfering with the sensor. However, utilizing the battery pack in accordance with the present disclosure would reduce the B field of the battery pack and therefore permit the sensor to be located in close proximity to the battery pack with minimal adverse effects on the sensor when current is produced by the battery pack.

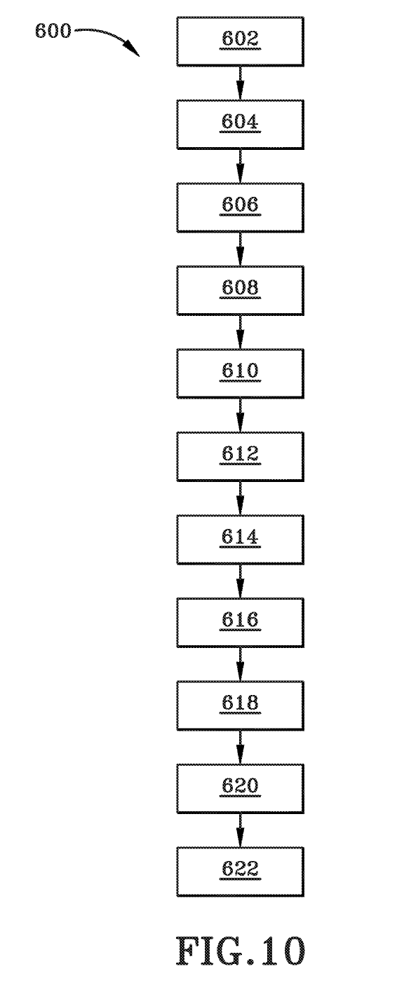

FIG. 10 is a flow chart showing the method 600 of reducing a magnetic dipole moment of a battery pack comprising, in a first step 602, providing a plurality of battery cells including a first battery cell and a second battery cell, wherein each of the plurality of battery cells has a positive terminal and a negative terminal; in a second step 604, arranging the first and second battery cells to form a stack. The stack is formed by, in a next step 606, positioning the first battery cell in a first orientation where the positive terminal of the first battery cell is on a first side of the stack and the negative terminal of the first battery cell is on a second side of the stack; and, in an additional step 608, positioning the second battery cell in a second orientation where the positive terminal of the second battery cell is on the first side of the stack and the negative terminal of the second battery cell is on the second side of the stack. The result of this is at least partially canceling 610 a magnetic dipole moment of the first battery cell with a magnetic dipole moment of the second battery cell.

Additional battery cells (i.e., other than the first battery cell and the second battery cell) may be added to the stack in a next step 612. The additional battery cells are, in a first example, added to the stack in pairs and in each pair the step of alternating the first and second battery cells and any additional battery cells in the stack between the first orientation and the second orientation is indicated by the reference number 614.

In a further step 616 the plurality of battery cells in the stack are arranged in wiring pairs where a current produced by a first battery cell in a first wiring pair is balanced with a current produced by a second battery cell in the first wiring pair; and are wired to the first battery cell to the second battery cell. Wiring between the first battery cell and the second battery cell in the first wiring pair; is twisted 618 thereby minimizing an area of a current loop from the first wiring pair.

Once the battery pack is fabricated, in a next step 620, the battery pack is installed in one of a UAV, a UUV, a space-limited application or a space-limited device that includes one or more magnetic sensors, wherein each of the one or more magnetic sensors or the application tolerates x-amount of magnetic interference; and in a step 622, generating less than x-amount of magnetic interference from the battery pack at the magnetic sensor.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration set out herein are an example and the present disclosure is not limited to the exact details shown or described.

1. A battery pack comprising:
a first battery cell and a second battery cell each having a positive terminal and a negative terminal; wherein the first battery cell and the second battery cell are arranged in a configuration where the positive and negative terminals are alternated; and wherein the first battery cell and the second battery cell each generate a magnetic dipole moment; and wherein the magnetic dipole moment of the first battery cell at least partially cancels out the magnetic dipole moment of the second battery cell.

2. The battery pack according to claim 1, wherein the first and second battery cells each have a first end, a second end and a side wall extending between the first end and the second end; and wherein the first and second battery cells are arranged in a first stack in a side-by-side configuration where the side wall of the first battery cell is in close proximity to the side wall of the second battery cell; and wherein the first and second battery cells are oriented in the first stack such that the positive terminal of the first battery cell is adjacent the negative terminal of the second battery cell; and the negative terminal of the first battery cell is adjacent the positive terminal of the second battery cell.

3. The battery pack according to claim 2, comprising a plurality of battery cells that includes the first battery cell and the second battery cell; wherein each of the plurality of battery cells has a positive terminal and a negative terminal; and wherein the first stack includes the plurality of battery cells arranged in the side-by-side configuration such that at a first end of the first stack the positive and negative terminals alternate and at a second end of the first stack, the negative and positive terminals alternate.

4. The battery pack according to claim 3, wherein the plurality of battery cells are arranged in the first stack in series.

5. The battery pack according to claim 2, wherein the plurality of battery cells are arranged in the first stack in in parallel.

6. The battery pack according to claim 2; further comprising additional battery cells provided in the first stack, wherein the additional battery cells are arranged in pairs such that magnetic dipole moments generated by the additional battery cells in each pair at least partially cancel each other out.

7. The battery pack defined in claim 3, further comprising a second stack of battery cells operatively engaged with the first stack; wherein the second stack of battery cells is positioned in end-to-end relationship with the first stack; and wherein the second stack of battery cells comprises a plurality of battery cells stacked together in a side-by-side configuration; wherein each of the plurality of battery cells in the second stack includes a positive terminal and a negative terminal; and wherein the battery cells in the second stack have alternating positive and negative terminals at a first end of the second stack and alternating negative and positive terminals at a second end of the second stack; and wherein the second stack is positioned adjacent the first stack such that the alternating positive and negative terminals at the first end of the second stack are located adjacent oppositely oriented negative and positive terminals at the second end of the first stack.

8. The battery pack according to claim 7, wherein each of the first stack and the second stack has an even number of battery cells therein; and wherein the number of battery cells in the first stack is the same as the number of battery cells in the second stack.

9. The battery pack according to claim 3, wherein the plurality of battery cells are arranged in the first stack to minimize an area of one or more current loops in the first stack.

10. The battery pack according to claim 9, wherein wiring connects pairs of battery cells of the plurality of battery cells together in the first stack; and wherein the wiring for each pair of battery cells is twisted to minimize the area of the one or more current loops in the first stack.

11. The battery pack defined in claim 9, further comprising wiring operatively engaging the plurality of battery cells together; and wherein battery cells that are adjacent each other are oriented opposite to each other and the wiring between battery cells that are adjacent each other carries equal and opposite currents.

12. A space-limited application or spaced-limited device comprising:
a housing;
a magnetic sensor provided in or on the housing of the space-limited application or device, wherein the magnetic sensor or the application tolerates x-amount of magnetic interference; and
a battery pack located within the housing to provide power to the space-limited application or device; and wherein the battery pack includes a plurality of battery cells arranged to produce a suppressed magnetic field and the suppressed magnetic field generates less than x-amount of magnetic intereference.

13. The spaced-limited application or space-limited device according to claim 12, wherein the battery pack is comprised of the plurality of battery cells arranged in a side-by-side configuration to form a stack; wherein each battery cell in the stack has a positive terminal and a negative terminal; and wherein a first side of the stack has alternating positive and negative terminals and a second side of the stack has alternating negative and positive terminals.

14. The spaced-limited application or space-limited device according to claim 13, wherein each of the plurality of battery cells in the stack generates a magnetic dipole moment; and wherein the magnetic dipole moments of battery cells that are adjacent each other in the stack at least partially cancel each other out.

15. A method of reducing a magnetic dipole moment of a battery pack comprising:
providing a plurality of battery cells including a first battery cell and a second battery cell, wherein each of the plurality of battery cells has a positive terminal and a negative terminal;
arranging the first and second battery cells to form a stack by:
positioning the first battery cell in a first orientation where the positive terminal of the first battery cell is on a first side of the stack and the negative terminal of the first battery cell is on a second side of the stack; and
positioning the second battery cell in a second orientation where the positive terminal of the second battery cell is on the first side of the stack and the negative terminal of the second battery cell is on the second side of the stack.

16. The method according to claim 15, further comprising:
at least partially canceling a magnetic dipole moment of the first battery cell with a magnetic dipole moment of the second battery cell.

17. The method according to claim 15, wherein the plurality of battery cells includes additional battery cells other than the first battery cell and the second battery cell; and wherein the method further comprises;
alternating the first and second battery cells and the additional battery cells in the stack between the first orientation and the second orientation.

18. The method according to claim 17, further comprising:
arranging the plurality of battery cells in wiring pairs;
balancing a current produced by a first battery cell in a first wiring pair with a current produced by a second battery cell in the first wiring pair; and
wiring the first battery cell to the second battery cell.

19. The method according to claim 18, further comprising:
twisting wiring between the first battery cell and the second battery cell in the first wiring pair; and
minimizing an area of a current loop from the first wiring pair.

20. The method according to claim 15, further comprising:
installing the battery pack in one of a UAV, a UUV, a space-limited application or a space-limited device that includes one or more magnetic sensors, wherein the application or at least one of the one or more magnetic sensors tolerates x-amount of magnetic interference; and
generating less than x-amount of magnetic interference from the battery pack.
